(19) United States
(12) Patent Application Publication
(10) Pub. No.: US 2024/0079657 A1
(43) Pub. Date: Mar. 7, 2024

(54) SOLID-STATE BATTERY

(71) Applicant: HONDA MOTOR CO., LTD., Tokyo (JP)

(72) Inventors: Takuya TANIUCHI, Saitama (JP); Terumi FURUTA, Saitama (JP)

(21) Appl. No.: 18/356,251

(22) Filed: Jul. 21, 2023

(30) Foreign Application Priority Data
Sep. 2, 2022 (JP) 2022-139910

(51) Int. Cl. H01M 10/0585; H01M 10/052

(52) U.S. Cl. CPC H01M 10/0585; H01M 10/052; H01M 2300/0065

(57) ABSTRACT

A solid-state batter is provided which includes an electrode stack in which a solid electrolyte layer and positive electrode composite layer are sequentially laminated on a lithium metal layer, in which, when viewing the electrode stack from a top surface, an outer circumferential end of the lithium metal layer exists more to an inner side than an outer circumferential end of the solid electrolyte layer, and an insulation member extending from the solid electrolyte layer towards the lithium metal layer is disposed in a region between the outer circumferential end of the lithium metal layer and the outer circumferential end of the solid electrolyte layer.

This application is based on and claims the benefit of priority from Japanese Patent Application No. 2022-139910, filed on 2 Sep. 2022, the content of which is incorporated herein by reference.

### BACKGROUND OF THE INVENTION

### Field of the Invention

The present invention relates to a solid-state battery.

### Related Art

In recent years, in order to configure so as to be able to maintain access to sustainable and advancing energy which is affordable and reliable for many people, research and development has been conducted on secondary batteries which contribute to higher efficiency in energy.

Patent Document 1 discloses an all-solid battery made by laminating two or more battery units in which at least a first electrode collector, first electrode active material layer, solid electrolyte layer, a second electrode active material layer, which is the counter electrode of the first electrode, a second electrode collector, a second electrode active material layer, a solid electrolyte layer and a first electrode active material layer are laminated in this order. Herein, the all-solid battery has an adhesion means for adhering the collector of a first electrode of a battery unit, and a battery unit stacked adjacent to the collector.
Patent Document 1: Japanese Unexamined Patent Application, Publication No. 2017-204377

### SUMMARY OF THE INVENTION

However, in the case of the negative electrode containing a lithium metal layer, dendrite of the lithium metal nonuniformly deposits on the lithium metal layer, when repeating the charge/discharge of the all-solid battery. This is assumed to be due to current concentration occurring in the plane of the lithium metal layer for some reason. As a result thereof, there is concern over the positive electrode and solid electrolyte layer migrating from a portion having a large deposition amount of lithium metal to portions of few, and the durability of the solid-state battery declining.

The present invention has an object of providing a solid-state battery capable of improving durability.

According to a first aspect of the present invention, a solid-state battery includes an electrode stack in which a solid electrolyte layer and positive electrode composite layer are sequentially laminated on a lithium metal layer, in which, when viewing the electrode stack from a top surface, an outer circumferential end of the lithium metal layer exists more to an inner side than an outer circumferential end of the solid electrolyte layer, and an insulation member extending from the solid electrolyte layer towards the lithium metal layer is disposed in a region between the outer circumferential end of the lithium metal layer and the outer circumferential end of the solid electrolyte layer.

According to a second aspect of the present invention, in the solid-state battery as described in the first aspect, the lithium metal layer is a rectangular shape when viewing from a top surface, and when viewing the electrode stack from a top surface, the insulation member is disposed at all corners of the lithium metal layer.

According to a third aspect of the present invention, in the solid-state battery as described in the first aspect, the lithium metal layer is a rectangular shape when viewing from a top surface, and when viewing the electrode laminate from a top view, the insulation member is disposed at opposing corners of the lithium metal layer.

According to a fourth aspect of the present invention, in the solid-state battery as described in any one of the first to third aspects, the insulation member is fixed to the solid electrolyte layer.

According to a fifth aspect of the present invention, in the solid-state battery as described in the fourth aspect, the solid electrolyte layer has a concave part formed in an outer circumferential part, and the insulation member is fixed to the concave part.

According to a sixth aspect of the present invention, in the solid-state battery as described in any one of the first to fifth aspects, the solid-state battery is packaged in an external member.

According to a seventh aspect of the present invention, in the solid-state battery as described in any one of the first to sixth aspects, the electrode stack has the lithium metal layer formed on a negative electrode collector, and the insulation member has an end face at the same position as a surface of the negative electrode collector on an opposite side to a side of the solid electrolyte layer, or at a position more to a side of the solid electrolyte layer than a surface of the negative electrode collector on an opposite side to a side of the sold electrolyte layer.

According to an eighth aspect of the present invention, in the solid-state battery as described in any one of the first to sixth aspects, a plurality of the electrode stacks are laminated, the insulation members which are opposing are disposed via a space, one of the insulation members which are opposing has a concave part formed in a surface on a side which is opposing, the other of the insulation members which are opposing has a convex part formed on a surface on a side which is opposing, and a part of the convex part overlaps with a part of the concave part.

According to a ninth aspect of the present invention, in the solid-state battery as described in any one of the first to eighth aspects, a second insulation member is disposed at an outer circumferential part of the positive electrode composite layer, and when viewing the solid-state battery from a top surface, an outer circumferential end of the second insulation member exists at the same position as an outer circumferential end of the solid electrolyte layer.

According to the present invention, it is possible to provide a solid-state battery capable of improving durability.

### BRIEF DESCRIPTION OF THE DRAWINGS

FIG. 1 is a top view showing an example of a solid-state battery of the present embodiment;

FIG. 2 is a cross-sectional view showing the solid-state battery of FIG. 1;

FIG. 3 is a top view showing a modified example of the solid-state battery of FIG. 1;

FIG. 4 is a top view showing a modified example of the solid-state battery of FIG. 1;

FIGS. 5A and B provide top views showing modified examples of the solid-state battery of FIG. 1; and

FIG. 6 is a cross-sectional view showing another example of the solid-state battery of the present embodiment.

### DETAILED DESCRIPTION OF THE INVENTION

An embodiment of the present invention will be explained hereinafter while referencing the drawings.

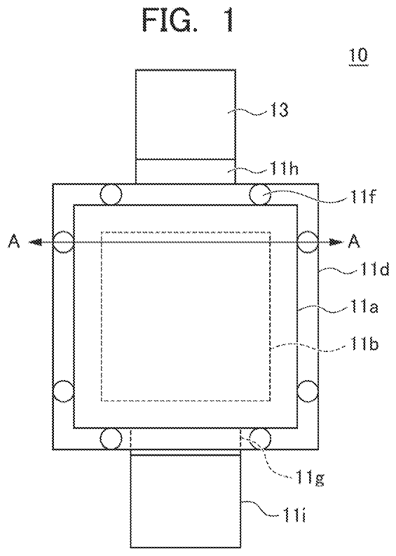

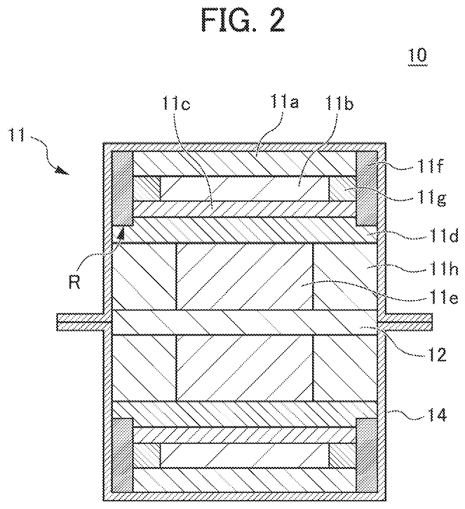

FIG. 1 and FIG. 2 show examples of a solid-state battery of the present embodiment. It should be noted that FIG. 2 is a cross-sectional view in the A-A direction of FIG. 1.

In a solid-state battery 10, a positive electrode collector 12 is sandwiched by an electrode stack 11 in which a lithium metal layer lib, intermediate layer 11c, solid electrolyte layer 11d and positive electrode composite layer 11e are laminated in order on the negative electrode collector 11a. At this time, when viewing the electrode laminate 11 from a top view, an outer circumferential end of the lithium metal layer 11b exists more to the inner side than the outer circumferential end of the solid electrolyte layer 11d, and a rod-like insulation member 11f existing from the solid electrolyte layer 11d to the lithium metal layer 11b is arranged in a region between the outer circumferential end of the lithium metal layer 11b and the outer circumferential end of the solid electrolyte layer 11d. In addition, in the electrode stack 11, a negative electrode insulator frame 11g is provided at the outer circumferential part of the lithium metal layer lib, and the insulation member 11f contacts the negative electrode collector 11a, negative electrode insulator frame 11g and intermediate layer 11c. Furthermore, in the electrode stack 11, the positive electrode insulator frame 11h is provided as a second insulation member to the outer circumferential part of the positive electrode composite layer 11e. In addition, in the electrode stack 11, the negative electrode tab 11i extends from the negative electrode collector 11a, and the positive electrode tab 13 extends from the positive electrode collector 12. At this time, the side in which the positive electrode tab 13 is extending is an opposite side to the side at which the negative electrode tab 11i is extending. In addition, the solid-state battery 10 is packaged by the laminate film 14 as an outer packaging member.

In the solid-state battery 10, since the insulation member 11f contacts with the negative electrode insulator frame 11g, the lithium metal layer 11 is fixed via the negative electrode insulator frame 11g, a result of which displacement of the lithium metal layer 11b is suppressed. For this reason, during charging of the solid-state battery 10, dendrite of the lithium metal hardly unevenly deposits on the lithium metal layer 11b, and durability of the solid-state battery 10 improves.

The cross-sectional shape of the insulation member 11f is circular; however, it is not particularly limited, and may be triangular, rectangular, polygonal or the like.

The material constituting the insulation member 11f, so long as not having electrical conductivity, is not particularly limited; however, for example, rubber, resins such as urethane resin, inorganic oxide, etc. can be exemplified.

It should be noted that the electrode stack 11 may omit at least one of the intermediate layer 11c, negative electrode insulator frame 11g and positive electrode insulator frame 11h as necessary. Herein, in the case of omitting the negative electrode insulator frame 11g, the insulation member 11f contacts with the lithium metal layer 11b. In this case, the lithium metal layer 11b may not necessarily exist in the initial state. In other words, the solid-state battery 10 may be anode free.

Furthermore, the electrode stacks 11 sandwiching the positive electrode collector 12 may be the same or may be different.

Herein, when viewing the lithium metal layer 11b from a top view, it is rectangular, when viewing the electrode stack 11 from a top view, two of the insulation members 11f are respectively arranged at all corners of the negative electrode insulator frames 11g. For this reason, displacement of the lithium metal layer 11b is suppressed. At this time, the insulation member 11f is arranged so as to be symmetrical at four points relative to the center point of the lithium metal layer 11b.

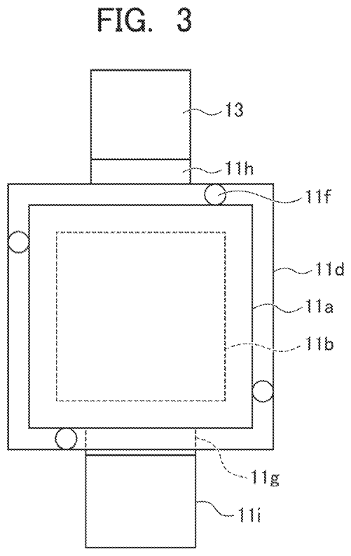

It should be noted that, when viewing the electrode stack 11 from a top view, one insulation member 11f may be arranged respectively at all corners of the negative electrode insulator frame 11g (refer to FIG. 3).

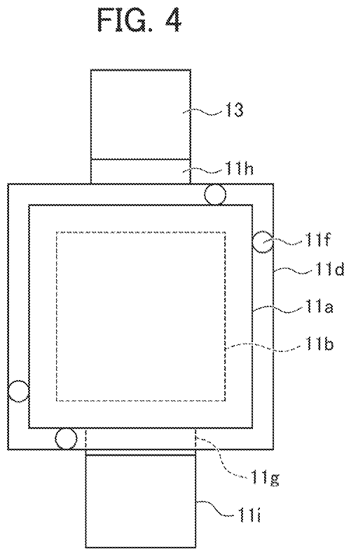

In addition, when viewing the electrode stack 11f from the top view, two of the insulation members 11f are arranged respectively at opposing corners of the negative electrode insulator frame 11g (refer to FIG. 4). At this time, the insulation member 11f is arranged so as to be two point symmetrical relative to the center point of the lithium metal layer 11b.

The insulation member 11f is fixed in a concave R formed at the outer circumferential part of the solid electrolyte layer 11d by a laminate film 14. For this reason, displacement of the lithium metal layer 11b is suppressed.

It should be noted that the concave part R may not necessarily be formed at the outer circumferential part of the solid electrolyte layer 11d. In this case, the insulation member 11f may be fixed to the solid electrolyte layer 11d by a jig.

In addition, instead of arranging a frame-like insulation member 11f to all corners of the negative electrode insulator frame 11g, a frame-like insulation member may be arranged to all sides of the negative electrode insulator frame 11g. In this case, the fixing method of the insulation member is not particularly limited; however, for example, a method of coating a coating liquid containing a UV curable resin, followed by drying or the like can be exemplified. At this time, in the case of the solid electrolyte layer 11d containing binder, due to easily fixing to the solid electrolyte layer 11d, the coating liquid containing binder included in the solid electrolyte layer 11d may be coated.

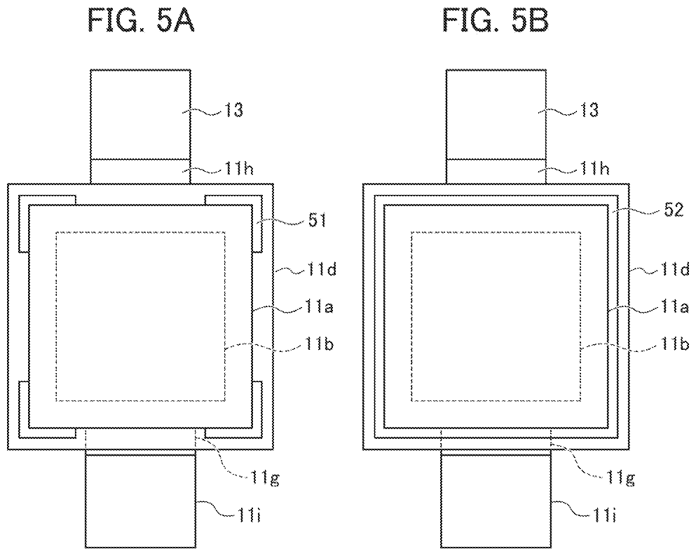

Furthermore, instead of arranging the frame-like insulation member 11f at the corner of the negative electrode insulator frame 11g, an insulation member 51 in which the cross-sectional shape is L-shaped may be arranged (for example, refer to FIG. 5A). In addition, instead of arranging the rod-like insulation member 11f at the corner of the negative electrode insulator frame 11g, a square-tubular insulation member 52 may be arranged at the surrounding of the negative electrode insulator frame 11g (refer to FIG. 5B).

The insulation member 11f has an end face at the same position of the surface on the opposite side to the side of the solid electrolyte layer 11d of the negative electrode collector 11a. It is thereby possible to reliably apply a restraining load to the lithium metal layer lib. At this time, even if the insulation member 11f has an end face at a position more to a side of the solid electrolyte layer 11d than the surface on the opposite side to the side of the solid electrolyte layer 11d of the negative electrode collector 11a, a similar effect will be obtained.

The negative electrode collector 11a is not particularly limited; however, for example, a copper foil, etc. can be exemplified.

When viewing the solid-state battery 10 from the top surface, the outer circumferential end of the intermediate layer 11c exists at the same position as the outer circumferential end of the negative electrode insulator frame 11g. For this reason, the interface of the lithium metal layer 11b and solid electrolyte layer 11d is stable.

It should be noted that the intermediate layer 11c has a function of uniformly depositing dendrite of the lithium metal.

The material constituting the intermediate layer 11c is not particularly limited; however, for example, carbon on which a metal capable of alloying with Li (for example, Ag, etc.) is supported or the like can be exemplified.

The solid electrolyte layer 11d is obtained by impregnating the solid electrolyte in the non-woven fabric, for example.

The solid electrolyte is not particularly limited so long as being a material which conducts lithium ions; however, an oxide-based electrolyte, sulfide-based electrolyte or the like can be exemplified.

In the solid electrolyte layer 11d, the strength of a region opposing the lithium metal layer 11b and/or positive electrode composite layer 11e may be higher than the strength of a region not opposing the lithium metal layer 11b and/or positive electrode composite layer 11e. Herein, the strength of the solid electrolyte layer 11d can be controlled by the blending of the solid electrolyte layer 11d (for example, content of solid electrolyte).

The positive electrode composite layer 11e contains the positive electrode active material, and may further contain solid electrolyte, conductive auxiliary agent, binding agent, etc.

As the positive electrode active material, so long as being a material which can occlude and release lithium ions, it is not particularly limited; however, LiCoO₂, Li(Ni_{5/10}Co_{2/10}Mn_{3/10})O₂, Li(Ni_{6/10}CO_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur, etc. can be exemplified.

When viewing the solid-state battery 10 from the top surface, the outer circumferential end on the side on which the negative electrode tab 11i extends of the negative electrode insulator frame 11g exists more to the outer side than the outer circumferential end of the negative electrode collector 11a. In other words, the negative electrode insulator frame 11g is formed also at a part on the side of the negative electrode collector 11a of the negative electrode tab 11i. For this reason, the occurrence of short circuit is suppressed, and the strength of the solid-state battery 10 improves.

The material constituting the negative electrode insulator frame 11g is not particularly limited; however, for example, an insulative oxide such as alumina, resin such as polyvinylidene fluoride (PVDF), rubber such as styrene-butadiene rubber (SBR), or the like can be exemplified.

The negative electrode insulator frame 11g may contain a material capable of expanding and contracting. The expansion and contraction of the lithium metal layer 11b accompanying charging/discharging of the solid-state battery 10 is thereby absorbed.

The material capable of expanding and contracting is not particularly limited; however, for example, rubbers such as fluorine rubber, silicone-based rubber or isoprene rubber or the like can be exemplified.

When viewing the solid-state battery 10, the outer circumferential end of the positive electrode insulator frame 11h exists at the same position as the outer circumferential end of the solid electrolyte layer lid. For this reason, upon producing the solid-state battery 10, variation in the laminating is suppressed. In addition, during charging of the solid-state battery 10, upon dendrite of the lithium metal depositing on the lithium metal layer lib, misalignment of the lamination of the solid-state battery 10 hardly occurs, a result of which dendrite of the lithium metal hardly nonuniformly deposits on the lithium metal layer lib.

When viewing the solid-state battery 10 from the top surface, the outer circumferential end on the side on which the positive electrode tab 13 is extending of the positive electrode insulator frame 11h is present more to the outer side than the outer circumferential end of the solid electrolyte layer 11d. In other words, the positive electrode insulator frame 11h is also formed on a part on the side of the positive electrode collector 12 of the positive electrode tab 13. For this reason, the occurrence of short circuit is suppressed, and the strength of the solid-state battery 10 improves.

The material constituting the positive electrode insulator frame 11h is not particularly limited; however, for example, an insulative oxide such as alumina, resin such as polyvinylidene fluoride (PVDF), rubber such as styrene-butadiene rubber (SBR), or the like can be exemplified.

The positive electrode collector 12 is not particularly limited; however, for example, aluminum foil or the like can be exemplified.

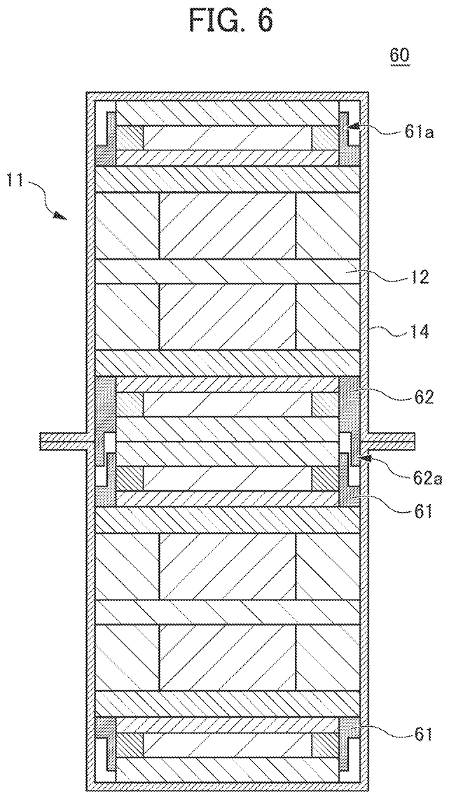

FIG. 6 shows another example of a solid-state battery of the present embodiment.

In the solid-state battery 60, the positive electrode collector 12 sandwiched by a plurality of electrode stacks 11 is laminated, and other than the insulation members 61 and 62 being used in place of the insulation member 11f, is the same as the solid-state battery 10. At this time, the opposing insulation members 61 and 62 are arranged via a space. For this reason, even when applying the restraining load, the insulation members 61 and 62 hardly contact. In addition, in the insulation member 61, a concave part 61a is formed in the surface on the opposing side, and in the insulation member 62, a convex part 62a is formed on the surface on the opposing side, and a part of the convex part 62a overlaps a part of the concave part 61a. For this reason, lamination misalignment of the positive electrode collector 12 sandwiched by the electrode stack 11 is suppressed. At this time, regarding the overlap between the part of the convex part 62a and part of the concave part 61a, even if dendrite of lithium metal deposits on the lithium metal layer 11b, it is configured so that the overlap exists. It should be noted that, at both ends in the lamination direction of the electrode stack 11 in which the insulation members 61 and 62 are not opposing, the insulation member 61 is arranged in consideration of strength.

Herein, the insulation members 61 and 62 are the same as the insulation member 11f except for the shapes differing.

Although an embodiment of the present invention has been explained above, the present invention is not to be limited to the above embodiment, and the above embodiment may be modified where appropriate within the scope of the gist of the present invention.

### EXPLANATION OF REFERENCE NUMERALS

10, 60 solid-state battery
11 electrode stack
11a negative electrode collector
11b lithium metal layer
11c intermediate layer
11d solid electrolyte layer
11e positive electrode composite layer
11f insulation member
11g negative electrode insulator frame
11h positive electrode insulator frame
11i negative electrode tab
12 positive electrode collector
13 positive electrode tab
14 laminate film
51, 52 insulation member
61, 62 insulation member
61a concave part
62a convex part
R concave part

What is claimed is:

1. A solid-state battery comprising an electrode stack in which a solid electrolyte layer and positive electrode composite layer are sequentially laminated on a lithium metal layer,
wherein, when viewing the electrode stack from a top surface, an outer circumferential end of the lithium metal layer exists more to an inner side than an outer circumferential end of the solid electrolyte layer, and an insulation member extending from the solid electrolyte layer towards the lithium metal layer is disposed in a region between the outer circumferential end of the lithium metal layer and the outer circumferential end of the solid electrolyte layer.

2. The solid-state battery according to claim 1, wherein the lithium metal layer is a rectangular shape when viewing from a top surface, and
when viewing the electrode stack from a top surface, the insulation member is disposed at all corners of the lithium metal layer.

3. The solid-state battery according to claim 1, wherein the lithium metal layer is a rectangular shape when viewing from a top surface, and
when viewing the electrode laminate from a top view, the insulation member is disposed at opposing corners of the lithium metal layer.

4. The solid-state battery according to claim 1, wherein the insulation member is fixed to the solid electrolyte layer.

5. The solid-state battery according to claim 4, wherein the solid electrolyte layer has a concave part formed in an outer circumferential part, and
wherein the insulation member is fixed to the concave part.

6. The solid-state battery according to claim 1, wherein the solid-state battery is packaged in an external member.

7. The solid-state battery according to claim 1, wherein the electrode stack has the lithium metal layer formed on a negative electrode collector, and
wherein the insulation member has an end face at the same position as a surface of the negative electrode collector on an opposite side to a side of the solid electrolyte layer, or at a position more to a side of the solid electrolyte layer than a surface of the negative electrode collector on an opposite side to a side of the sold electrolyte layer.

8. The solid-state battery according to claim 1, wherein a plurality of the electrode stacks are laminated,
wherein the insulation members which are opposing are disposed via a space,
wherein one of the insulation members which are opposing has a concave part formed in a surface on a side which is opposing,
wherein the other of the insulation members which are opposing has a convex part formed on a surface on a side which is opposing, and
wherein a part of the convex part overlaps with a part of the concave part.

9. The solid-state battery according to claim 1, wherein a second insulation member is disposed at an outer circumferential part of the positive electrode composite layer, and
wherein when viewing the solid-state battery from a top surface, an outer circumferential end of the second insulation member exists at the same position as an outer circumferential end of the solid electrolyte layer.
